(19) United States
(12) Patent Application Publication
(10) Pub. No.: US 2006/0069995 A1
(43) Pub. Date: Mar. 30, 2006

(54) Personalised process automation

(75) Inventors: Simon Giles Thompson, Ipswich (GB); Nick Giles, Ipswich (GB); Hamid Gharib, Ipswich (GB); Yang Li, Ipswich (GB)

Correspondence Address: NIXON & VANDERHYE, PC, 901 NORTH GLEBE ROAD, 11TH FLOOR, ARLINGTON, VA, 22203, US

(73) Assignee: BRITISH TELECOMMUNICATIONS public limited company, London (GB)

(21) Appl. No.: 11/233,376

(22) Filed: Sep. 23, 2005

(30) Foreign Application Priority Data
Sep. 30, 2004 (GB) 0421751.9
Dec. 10, 2004 (GB) 0427114.4

(51) Int. Cl. G06F 3/00

(52) U.S. Cl. 715/700

(57) ABSTRACT

A service-composition framework arranged to generate a personalised order process for a user seeking to fulfil a service goal by composing a process from a multiplicity of registered services, the framework comprising: a service engine configured to compose one or more services into an order for offering to a user, each service comprising a plurality of actions to be performed; a portal via which the user can request said one or more services from said service engine to fulfil said service goal, the portal being arranged to enable the user to select which services are to be offered, wherein the framework is configured to dynamically determine both the plausibility and the feasibility of the services offered to the user whilst the user is executing their request for services via the portal and to maintain the users status and personal information within a session context.

The present invention relates to a framework, method and system for providing a personalised order process, in particular, but not exclusively, to a web services composition framework for providing a personalised order process to a business entity.

The framework is congruent with the Representational State Transfer (REST) philosophy of loosely coupled services. REST is a model for web services based on HTTP alone. According to REST any item can be represented at a Uniform Resource Identifier (URI) and manipulated using the HTTP defined operations without any additional specifications being required.

Although a Java framework is described, those skilled in the art will appreciate that the invention extends to any appropriate programming environment capable of providing the necessary mechanisms to manipulate network and computer resources required to develop a service composition framework and which supports the development of applications where an agent, of varying intelligence, assists a user in the composition of various services.

Examples of the kind of application which can be developed using the Java framework according to the invention include well known agent applications such as personal travel assistance and personal tuition planning.

The invention further relates to a set of tools which assist the user of the framework in creating the services that the user is to compose and in validating and experimenting with the composition at compile time.

One known toolset is the Zeus toolset (for more details see Nwana et al, “ZEUS: A tool-kit for building distributed multi-agent systems” Applied Artificial Intelligence Journal, 13(1), 1999, p. 129-186. However Zeus implements a close-coupling when modelling planning, price discovery, and scheduling, and this together with its distributed planning model limit the implementation of realistic applications. Moreover, it is not straightforward to implement web-based applications using the Zeus architecture.

Webber, J. (2004) Web Services: REST in Peace WebServices.org Jan. 8, 2004 http://www.webservices.org/index.php/content/view/full/39565] describes how the REST community believes that invocations in web-scale application infrastructures should enable the transfer of the state of a resource (such as a document) between actors in terms of a mutually understood verb. The relevant service transfer verb is sometimes sited as “processThis”, alternatively, however, two verbs “doThis”—perform and “getThis”—query might be more appropriate.

The development of applications can lead to the conflation of function and process. The actual processing steps contain code which determines their orchestration. Increasingly the complexity of the workflows is a problem as more and more options are developed etc, and the product and service portfolios offered in a web-service environment become more and more complex. In this context, the development of declarative workflow systems that can make the knowledge engineering of workflow development easier and maintenance cheaper and quicker is highly desirable.

In order to provide a solution to a user specified goal using a set of distributed services (agents, web-services, plan actions, components, capabilities) a number of approaches can be used. If tacit processes are used such as those implemented in ADEPT-type systems (see ADEPT: An Agent-Based Approach to Business Process Management, Jennings et al, obtainable for example via http://www.ecs.soton.ac.uk/˜nrj/download-files/acm-sigmod.ps.gz), where the process is encoded in the agent interactions and reasoning there is no straightforward facility for inspection and comprehension. The agents internal decision making processes are not made available for analysis in typical systems because this would enable other participants to anticipate their future actions and behaviours.

The present invention seeks to obviate and/or mitigate problems associated with known toolsets by providing an improved framework and toolset for web-service composition. The invention implements an artificially intelligent (AI) planner to combine the following sources of operational context: firstly, the availability of actions in an enterprise directory; secondly, generic context knowledge; and finally, user specific context knowledge. These provide operational context for the service-composition framework and are combined using the AI planner to provide an upfront process for delivering a particular service episode. The goals of the user are added to the user's session, and the interactions with the system are managed through the session, including updates to the user's context information caused by the execution of the generated process. It is noted that multiple users may be conducting separate sessions simultaneously using one instance of the present invention running on one server or computer.

The invention effectively divides the process creation problem into two components. Firstly, the solution is constructed to be plausible in the sense that there exists one state of affairs (outcome of the chain of execution of services) such that the process will successfully complete. Secondly, when the process does not (as is often the case) execute according to plan, this is detected by the invention using a set of feasibility tests which are executed by each service to detect if the outcome of the previous service in the execution chain is as expected. As the execution of any service updates the users context, when the process fails and the goal is reasserted as a consequence, the new plausible service will be compliant with the outcome of the previous service.

The aspects and preferred features of the invention are as set out in the accompanying claims. Those skilled in the art will appreciate that the preferred features of the invention can be combined with any suitable aspects of the invention in any appropriate manner.

Embodiments of the invention will now be described with reference to the accompanying drawings which are by way of example only and in which:

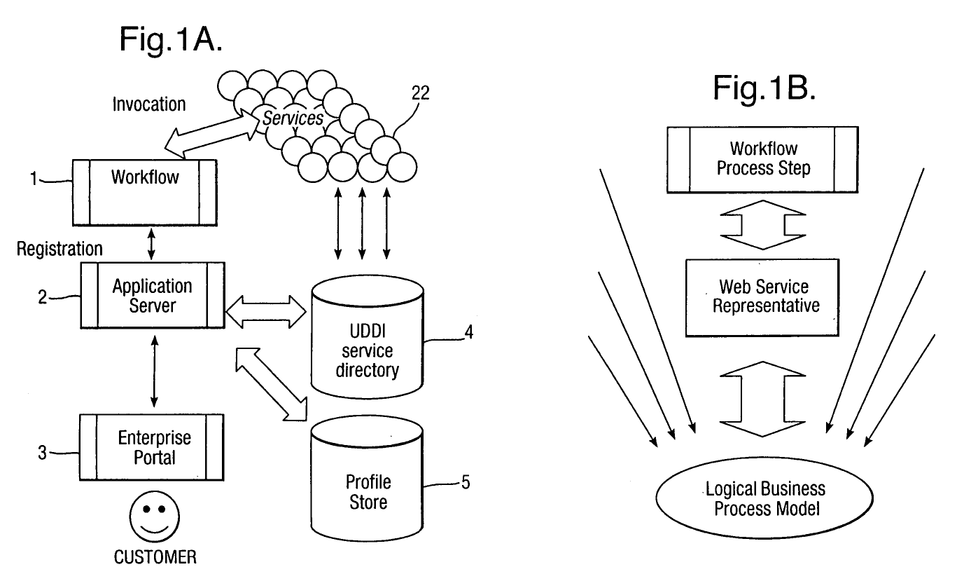

FIGS. 1A and 1B show schematically how web-services are related to business process according to the invention;

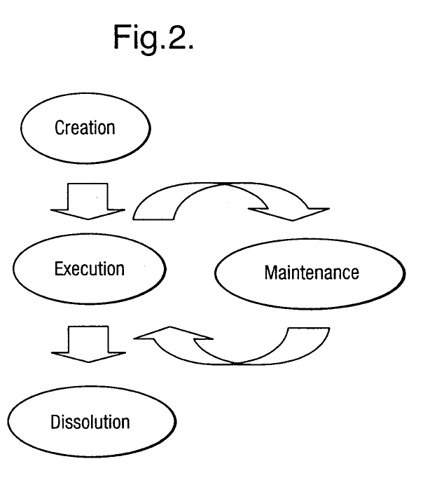

FIG. 2 shows schematically the service provision and management lifecycle;

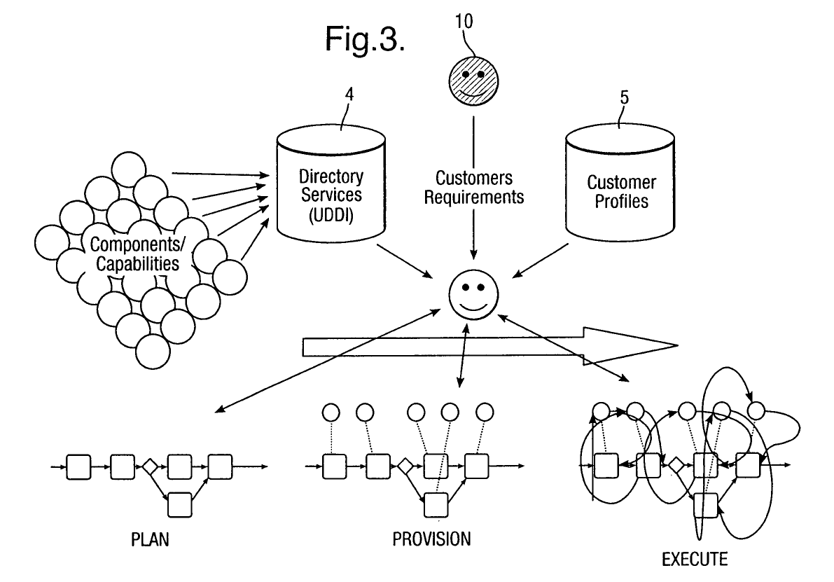

FIG. 3 shows a problem solving context diagram for a framework according to the invention;

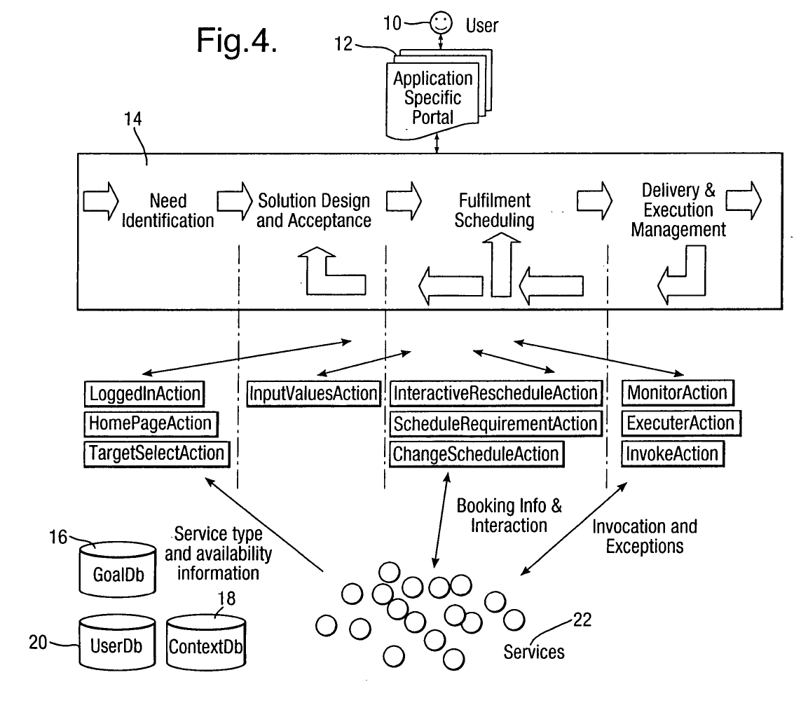

FIG. 4 shows the interaction model for a framework according to one embodiment of the invention;

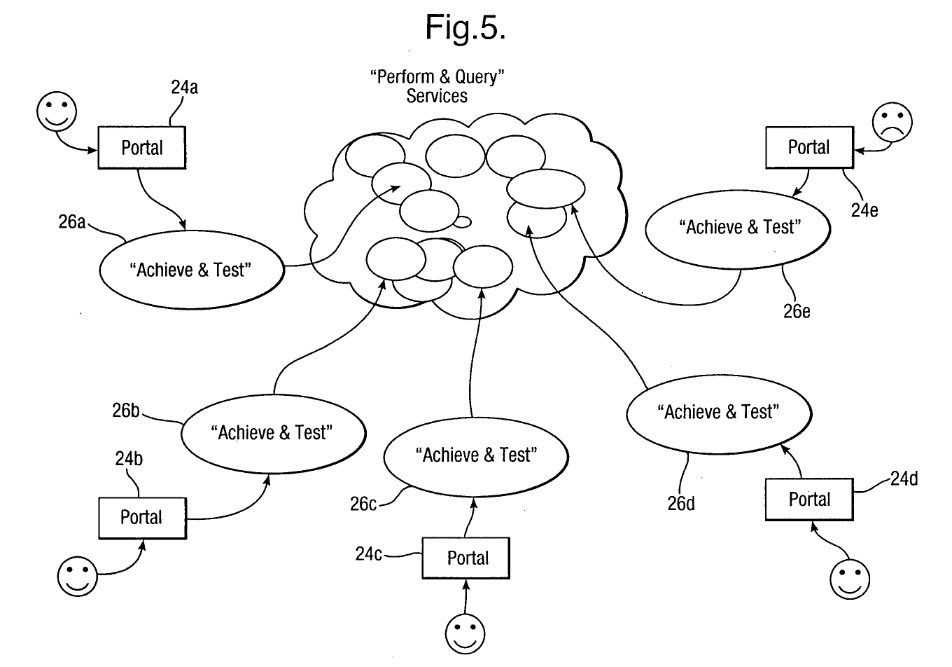

FIG. 5 shows a service interaction and invocation model in a framework according to an embodiment of the invention;

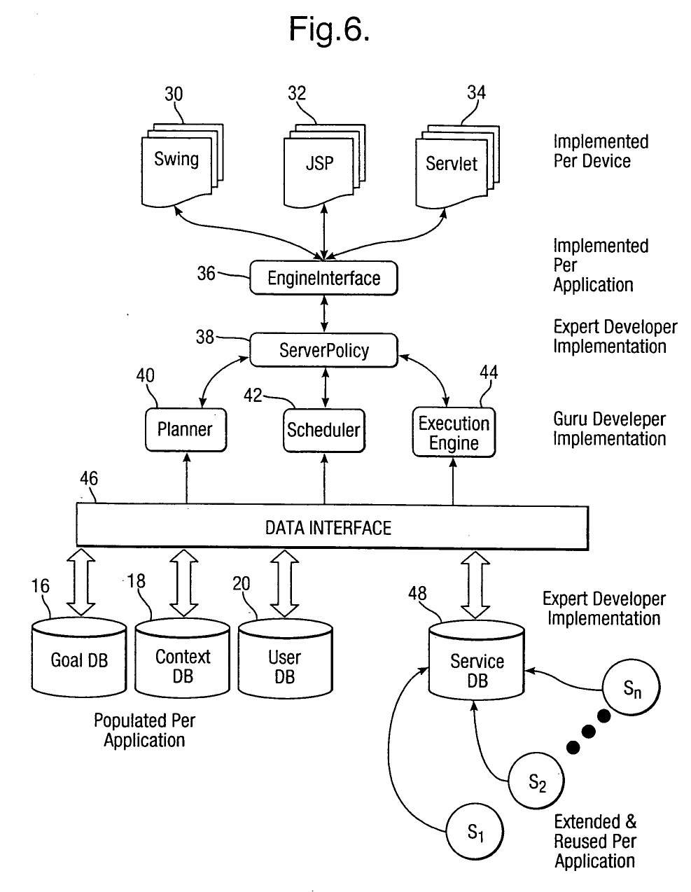

FIG. 6 shows the framework architecture;

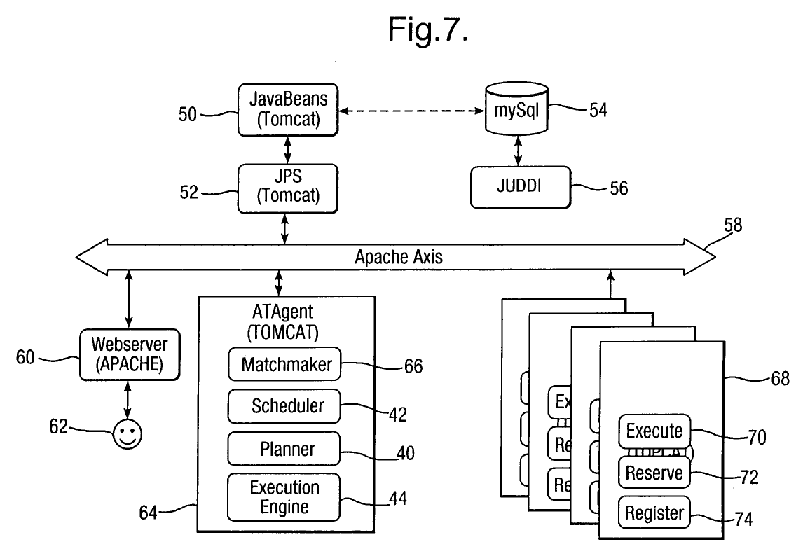

FIG. 7 shows the framework implementation;

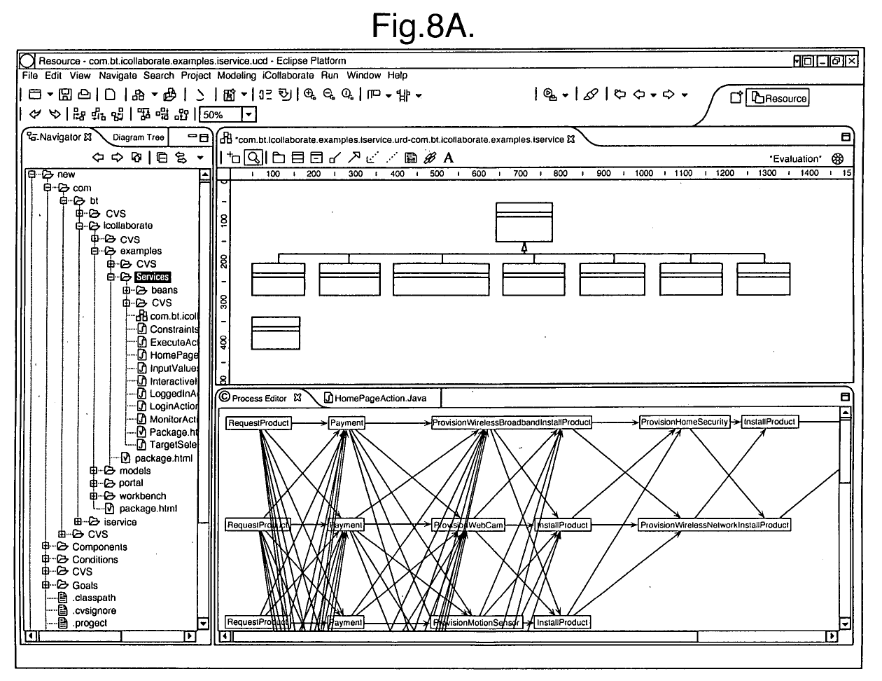

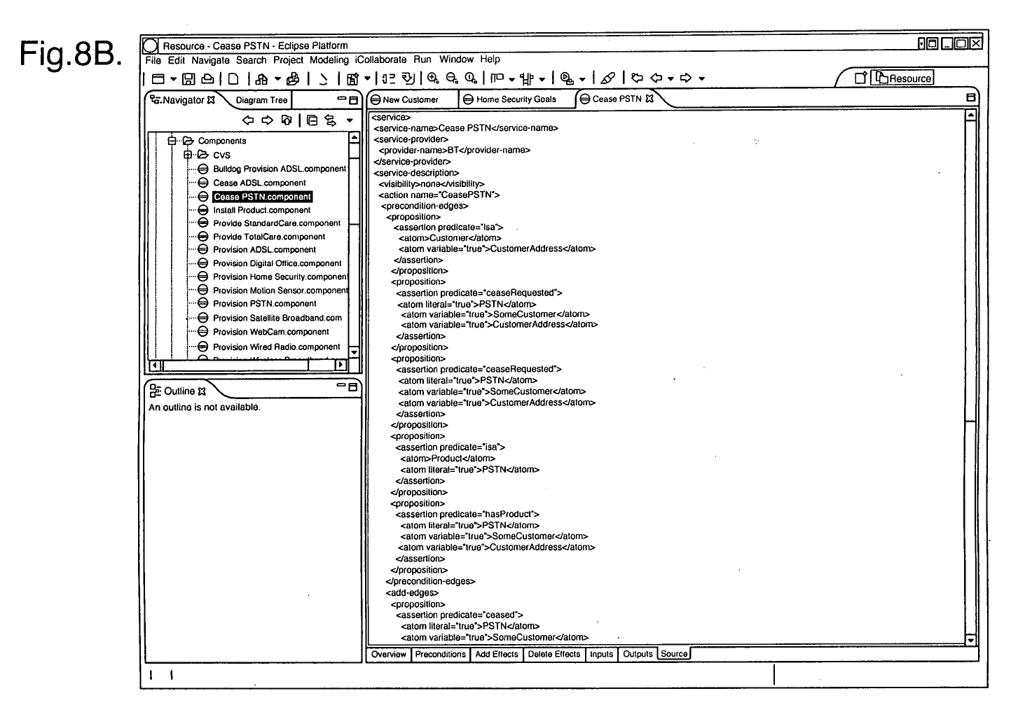

FIGS. 8A and 8B are screen shots showing the toolset plan inspection, component editor and UML;

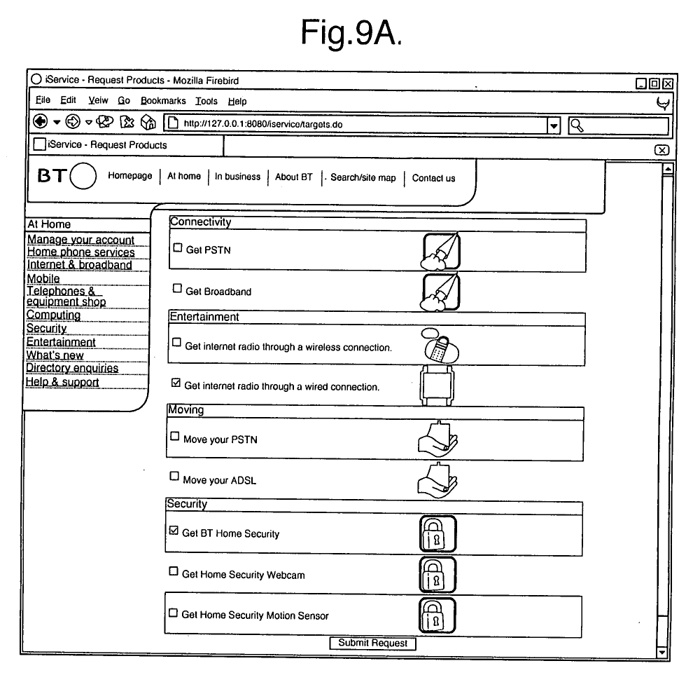

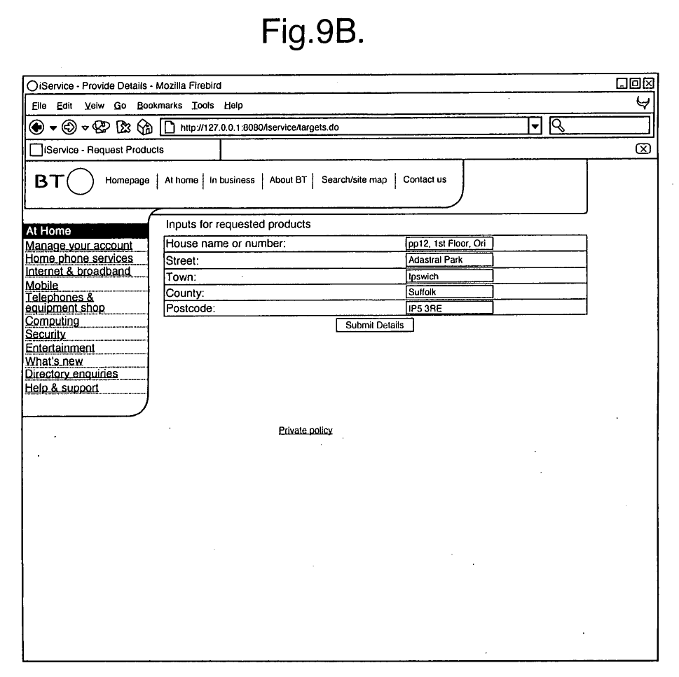

FIGS. 9A and 9B are screen shots of how user requirements are gathered according to one embodiment of the invention;

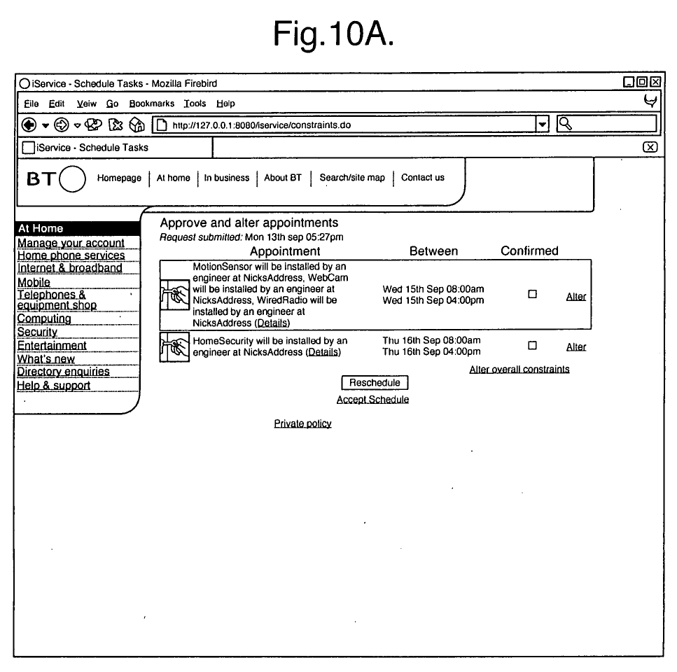

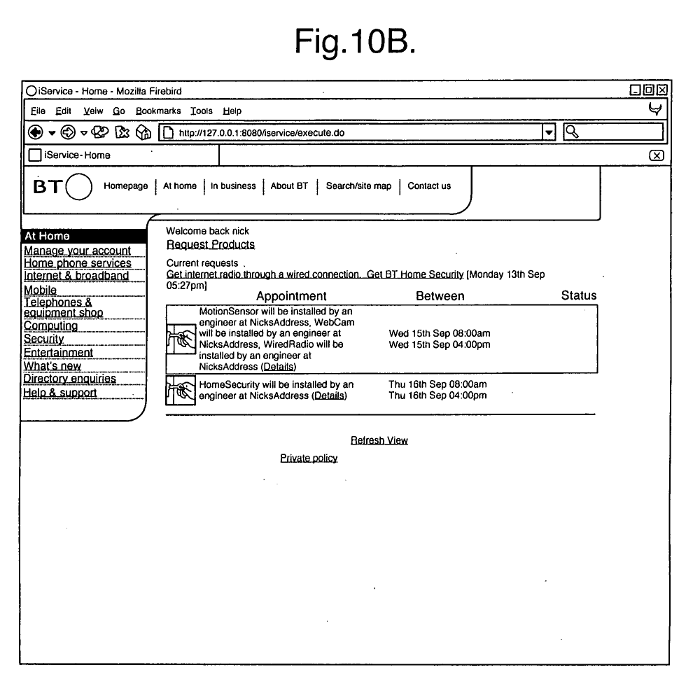

FIGS. 10A and 10B are screen shots showing the user appointing, fulfilment scheduling and delivery execution phases of the invention;

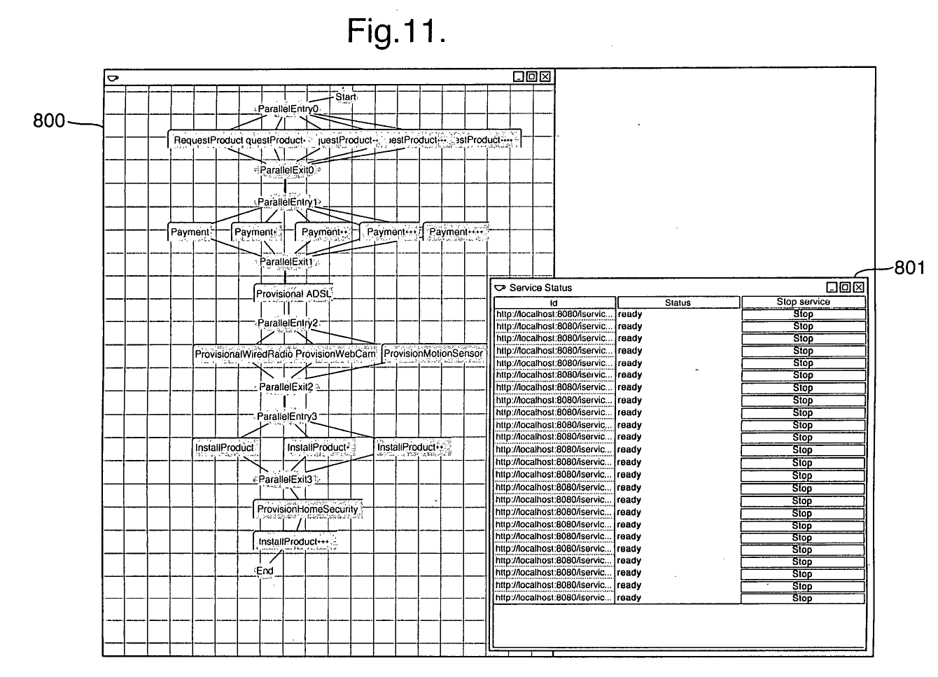

FIG. 11 shows monitoring screens in an embodiment of the invention;

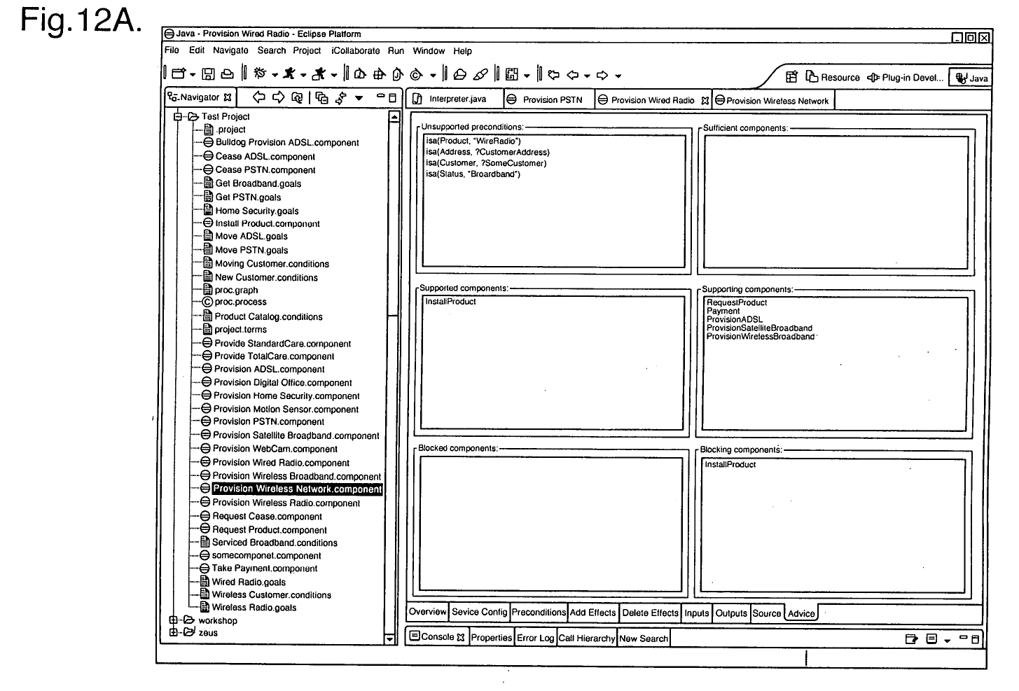

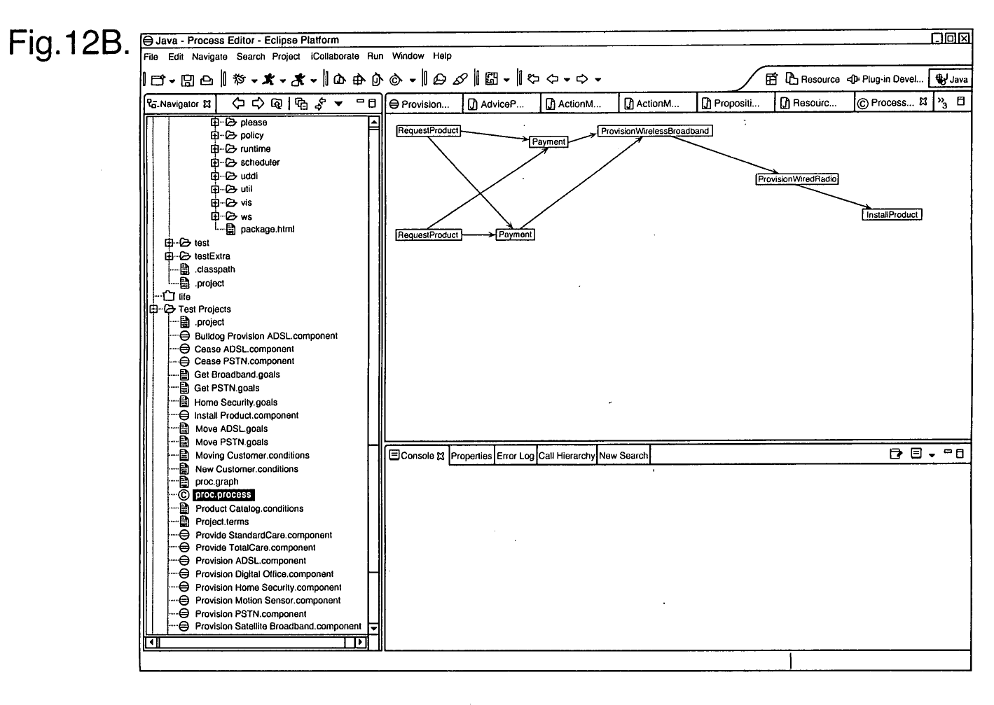

FIG. 12A shows a screen shot of the Service Advice editor implemented on the Eclipse IDE according to one embodiment of the invention; and

FIG. 12B shows the Proof Visualisation viewer as implemented in the Eclipse IDE using SWT according to one embodiment of the invention.

The best mode of the invention will now be described. Those skilled in the art will find apparent many variants functionally equivalent to the specific features described and the invention is intended to encompass such features where they are apparent to those skilled in art. Accordingly, the scope of the invention is to be determined by the accompanying claims rather than limited by the specific features of the embodiments described below.

The invention provides a service-composition framework arranged to generate a personalised order process for a user seeking to fulfill a service goal. The framework has to derive the best set of actions in order to achieve the user's goal(s) at a particular time. The invention implements a solution to this problem by providing a framework for service composition including, for example, the following components:

i) A system in which the various normal actions of a business have a normal lifecycle; they can become available; they can be discovered and compared; they can be used; they can be removed.

ii) Mechanisms that allow the actors in the process to decide on what they should do; when should we choose a particular action from a plausible set of actions, such that it is to be used in a workflow for a particular customer? When should we agree to perform an action for a customer, how much should we charge?

iii) Mechanisms that can resolve the problems and puzzles that confront decision makers in such an environment. How should we choose between vast numbers of possible suppliers for all the actions in a workflow? How should we decide which of the windows in a possible schedule should be opened for bidding to our suppliers?

iv) Mechanisms for dealing with events and things that go wrong (exceptions).

The infrastructure required is provided by a service orientated architectures, for example, using the web services standards based technologies of UDDI, SOAP and WSDL.

Referring now to FIGS. 1A and 1B of the accompanying drawings, the way in which services, for example, web-services are related to business processes according to the invention is shown schematically. In general, the term “web service” refers to anything from “a service provided using a browser” to “services provided using a web service resource framework (WSR)F”. Web Services Resource Framework web services define conventions for managing ‘state’ so that applications can reliably share changing information. The term “service” is used here to refer to a functional unit of program code, and the term “web service” implies that the functional unit of program code is invoked using a call sent over HTTP to a socket that is being listened to by that code, and the call is encoded in SOAP which is a dialect of XML. Furthermore all web services are registered in a UDDI directory using t-models and the WSDL service registration language. Further information is referenced from the services registration in UDDI and is stored in the form of web pages served using the normal HTTP protocol from resources represented using a URL. In the current embodiment this information is in the form of state change information similar to the functional propertied (input, output, precondition and effect) defined in the OWL-S standard (obtainable for example from http://www.daml.orq/services/owl-s/1.1B/Profile.owl) coded as expressions in XML. This enables a system of web services to represent and to manipulate a real business process.

FIGS. 1A and B illustrate how a predefined action, a step in a business workflow 1, is mapped to a web service representative via application server 2. This service representative then registers itself in the UDDI directory infrastructure 4. This information is discovered, by directory lookup and then composed into an overall logical model of the system of predefined actions that are available in the scope of the system. The service orientated architecture that enables the information flow illustrated schematically in FIG. 1B is shown in FIG. 1A.

FIG. 1A shows how the framework includes a profile store 5 for storing customer profiles. Each profile of a customer establishes the context in which the service episode is taking place. The profile contains data on the customers address, status and history. The data is recorded in the form of assertions that can be manipulated by the planner. As the process produced by the planner is executed various assertions are made as a side effect of the services that are invoked. These are written back into the profile so that the next time the planner is run they will be taken into account. The effect of using this technique is to make the system responsive to the customer's circumstances.

The UDDI directory 4 is used to provide a duel function registry of business services. The information registered is used to provide the planner with information on the current functional abilities of the organization; what types of action or service are available for use at a particular time. Information on the currently available service providers can be used in the matchmaking phase to provide provisioning information. Each service is described through a UDDI registration and a link in the registration T-model to a capability description with the knowledge required for reasoning by the planner encoded in XML.

The knowledge in the Profile and the Business Services Directory is loaded into the service composition framework applications application server. Once the model is assembled in the application server or business logic layer, it can of course be manipulated logically and therefore computationally. To ensure that the space of the computational problems generated by the models is tractable, i.e. to cope with their complexity, heuristic techniques which are well known to those skilled in the art of artificial intelligence can be used to limit the processing demands of the system. Thus any suitable heuristic algorithm can be used to reduce the complexity of the problem of ordering actions when the order process includes goals requiring the creation of processes containing a large number of actions or requiring that very large numbers of alternate actions can be searched.

FIG. 2 shows schematically the service provision and management lifecycle the service composition framework supports in one embodiment of the invention. This embodiment is similar to a virtual enterprise lifecycle however there are some important differences as the service composition system of the invention does not assume an open service environment [for more details see Luck, M. Munroe, S. & d'Inverno, M., (2003) Autonomy: Variable and Generative, in Agent Autonomy, H. Hexmoor, C. Castelfranchi, and R. Falcone (eds.), Kluwer, 9-22, 2003] in which service providers may be completely unknown to the managing system components. Instead, it is assumed that all the service providers in the system are known to the managing components that are owned by the point of contact used by the customer. In alternative embodiments of the invention, the framework is implemented in managed environments in which the service providers are constrained to be from selected service providers which have adopted the required conventions and standards of behaviour and have entered into binding agreements with the point of contact before entering the environment.

In service composition system described herein, in order to cope with combinatorial problems and retain solution quality, the framework constrains problems which have no efficient solution algorithm with the output of efficient, quick algorithms.

Referring now to FIG. 3 of the accompanying drawings, an embodiment of a problem solving context diagram for one embodiment of the invention is shown. In FIG. 3, the context of the episode is first established by considering the basic assertions of a customer 10. These assertions are considered from the customer's (the term “customer” is used synonymously with “user” in some embodiments of the invention) profile in customer profile store 5 and the business context is populated by discovering the list of service classes from the UDDI directory 4. The customer's/user's goals are established from the portal interface 12 (see FIG. 4). A logical planner 40 (see FIG. 6) is used to deduce an ordering or sequence of the available actions which is legal given the assertions from the customers profile. This sequence is then provisioned using the service instances registered in the directory to obtain a solution, solₓ. This solution is then fed into an engine which invokes the services according to the provisioned plan. If an exception occurs either alternate service providers are identified in real time, or the process is stopped and a new solution solₙ is derived using the same method as before. If no new solution solₙ can be found then it is not possible for the organization to achieve the goals that have been set for it.

Thus the web services composition framework according to the invention is a partially instantiated design pattern for applications that enable users to create bespoke solutions to their particular requests in particular domains by composing the offerings of a number of service providers and executing the resulting composite solution. In addition to utilizing the pattern implemented in the framework in the current embodiment those skilled in the state of the art will understand that a mechanism such as the Zeus problem solving graph system (Nwana et al) can be used to customise the flow of control in the system.

The web services composition framework according to the invention is effectively providing solutions which are dynamically constructed using a means-end planner. The knowledge of the planner (e.g. the task knowledge) is provisioned automatically into the system using service registration, look up and discovery. There is no requirement for any planning or process knowledge to have been encoded in the system and processes are created dynamically before they are instantiated. The framework enables plans to be produced with are rendered into bespoke, runnable business processes (in the form of a BPEL-like XML description), which becomes the controlling object for further operation.

The execution of the process is monitored and tagged to the goal(s) that established it, and the user who created those goals in the system. Similarly, the web services composition tool set which assists the user in creating and validating the web services composed using the framework provides a scenario modelling system which enables the user to develop and test ideas for systems enabled by the web service composition framework.

The user's interaction with the system according to one embodiment of the invention is managed within the model illustrated in FIG. 4 of the accompanying drawings. In FIG. 4 a user 10 interacts via an application specific portal 12 to obtain services 22. In FIG. 4, the portal 12 is implemented to utilise the framework 14 in four stages, namely, in a first stage the identification of the user's needs, in a second stage solution design and acceptance, in a third stage fulfilment scheduling, and finally a delivery and execution management stage.

The flow of the application between these phases in the current embodiment is fixed, although it could alternatively be open. Initially the user's session is established and information about available services (goals) is rendered to enable the user to make appropriate selections or decisions. Possible solutions are designed by the web services composition framework planner. One or more possible solutions are then rendered to the user for selection. Next a fulfilment schedule is presented to the user and then modified. The executing process is monitored and the information on progress is rendered. Any exceptions are also rendered and the user is taken back to the appropriate stage either to redesign the solution or to reschedule the fulfilment. The various actions performed in each stage are also shown in FIG. 4.

The front-end of an application needs to be produced by the developer of the application, using the stubs and access points provided into the framework. For instance, Java Server Pages (JSP) might be produced, along with Java beans and control servlets to manage the interaction pattern.

A goal data base listing available services (GoalDB 16 shown in FIG. 4) comprises the goals that the system can achieve. Also shown in FIG. 4 is a context database ContextDB 18 which comprises the environment relevant knowledge which is relevant to all interactions with the system and a user data base UserDB 18 which contains the knowledge the system has for each user. UserDB 18 is used to load knowledge on a “per user” basis and must also be provisioned with the required knowledge for the interaction.

Each interaction episode is in the context of a user session and therefore the planner knowledge in the environment is also in that user context. This means that the processes generated by the user's interactions are by default personalised to the user and the system is able to update the knowledge of the user during execution and take this into account in the case of an exception or in the case of subsequent service requests.

In one embodiment, the invention seeks to provide a system which is able to collaborate with a user (human) in a particularly simple manner. In one embodiment of the invention, services 22 are selected from a list in which each selection (individually) is provisioned by a number of different available services. Each of the different available services has a range of differing interactions with other services on the list. This is a straightforward use of the technology. As an example, a list of affordable destinations that have hotel availability during periods when the user does not have bookings in their diaries could be generated to prompt users to create a detailed goal specifying their holiday destination and dates.

Alternatively, the implementation of the interface and its mediation to the systems logic and knowledge can be much more sophisticated in other embodiments of the invention, for example, by using filtering options and domain dependent information to provide support to the user. Consider an embodiment in which the system is used to prepare an e-learning curriculum for a student of the French language. A quiz can be implemented to elicit what the user wants from the course, what financial and time resources they have (to visit France, to purchase appropriate materials) and to discover the student's current competence. In this case the knowledge of the users previously taken modules can be used to ensure that only new material is presented.

According to the invention, activities of an implemented framework system are generated by the user in response to the information on the system that is exposed to the user. This interaction is facilitated by the code created by the programmer to implement the layer of actions that drive the user interface in the web portal. The user is prompted to create new requests, which may be unanticipated at design and implementation time, but can be achieved given the systems set up.

The services in the framework according to the invention are subordinate to the user and core engine. They are only capable of enacting “perform” goals, enumerated service requests. Effectively, they “do as they are told” and are assumed not to have any capacity for improvisation or goal combination. In addition to providing “perform” functionality “query” functionality is also provided in the form of the services ability to answer a limited range of questions about its utilisation.

FIG. 5 of the accompanying drawings shows a system model for the framework. In FIG. 5, the service interaction and invocation model for the framework resulting from the dichotomy of service provider and service initiation and creation systems is shown. Such an embodiment has been implemented using a framework in which a tier of accessible “achieve & test” nodes 26a, collaborate (via the mediation of the application or portal) with their users to access services from the tier 2 “perform and query” services. In this embodiment, the two types of entity are referred to as “ATAgents” and “PQServices” respectively.

Each portal 24a,24b, 24c, 24d, 24e provides access to “Achieve and Test” functionality; it can be used to cause a goal of the user to be achieved or it can be used to test that a goal can be achieved. The services implemented using the framework in this embodiment of the invention provide “Perform and Query” functionality only.

PQServices are subordinate components that only interact with users indirectly. Communications interfaces have been selected for the PQService on the basis of ensuring that they are simple to develop, compliant with standards and extensible. In order to facilitate this the POServices have a communication interface with two separate concerns; the general reuseable communication mechanism (the application concern) and the infrastructure maintenance communication mechanism (the housekeeping concern).

The POService interface that is used in the framework according to the invention is implemented to utilise these two verbs. This minimises the tasks that a PQService developer must complete in order to link a functional module into a framework/toolset system according to the invention. In addition the exchange of information in the form of parameters is considered only as a call to a specific “perform” service and not as a general purpose call to a belief base. Thus this embodiment of the invention selectively focuses only on request and query functionality and supports these functions via direct API calls without a general purpose content language. Content is exchanged between POServices and ATAgents only in the form of XML formatted data.

In practice supporting the Process and Query verbs means that PQServices are obliged to be able to answer Process and Query requests including:
Resource availability (booking) information query and response
Resource booking request, confirm and cancel
Execution of service on receipt of a booked request with exception generation and input validity testing to ensure process consistency and control.

Each PQService is expected to implement the following API calls:

i) Registration to the service directory being used. In the default implementation developed this is a Universal Description, Discovery and Integration UDDI directory run using the jUDDI open source implementation;

ii) Liveness “ping” testing.

Service registration and description is achieved in the default framework implementation using a UDDI registration that contains an annotation field with a URL that points to an eXtensible Markup Language (XML) page which has the relevant service mark-up. We have used a simple XML format that abstracts some of the features of DAML-S/OWL-S in the form of the IOPE (Input, Output, Precondition and Effects) of the service. Typing of items is in the form of references to fragments in XML Schema Definition (XSD) schemas; data types in the invocation of registered service invocation functionality are typed and by XSD specified XML. This registration procedure is explained in more detail in terms of an XML goal definition later hereinbelow. Liveness or “ping” testing allows monitoring systems to support “heartbeating” across services and to gauge availability of services before attempting to interact with them.

The architecture for the ATAgent implementation framework is illustrated in FIG. 6 of the accompanying drawings. In the embodiment shown in FIG. 6, the key processing units are the Planner 40, the Scheduler 42 and the Execution Engine 44. These processing elements are orchestrated from the ServerPolicy module 38 which interacts with the processing units 40,42, 44 via their API interfaces. The EngineInterface module 36 interacts with the ServerPolicy module 38 and is utilised by the programmer when the user interfaces (shown in FIG. 6 as Swing user interface 30, Java Server Pages user interface 32 and servlet user interface 34) of the application are implemented.

The flow of control of the system which the programmer uses the framework to implement was shown in FIG. 4, which showed the various phases or steps in the systems operation as a Need Identification stage, a Solution Design and Acceptance stage, a Fulfilment Scheduling stage and a Delivery & Execution Management stage.

In the invention, every application requires a new implementation of the user interface and goal (services) data store 16, context knowledge datastore 18 and user datastore 20. These elements are tightly coupled to particular applications. Services 22 may be reused from application to application or may be supplemented or replaced by the engineer. The ServerPolicy will typically be reused by different applications but detailed control of the interaction of the processing components may be required and if so, the ServerPolicy must be re-implemented. Although the processing units 40, 42, 44 are pluggable, it is anticipated that in the best mode of the invention they will rarely be re-implemented. The exception is the Execution Engine 44 for which many users and enterprises have standard products. In the embodiment of the invention shown in FIG. 6, plans and workflows are not explicitly implemented into the portal, so there is no process library—in the framework according to the invention the plan for delivery is generated dynamically on demand.

Need Identification

In the framework according to the invention, the needs of the user are translated into goals of the system. Accordingly, in order to meet the same need of different users, different goals may be required to be achieved. For example a particular service may not be available in a particular geographic area; alternatively users may have a sight impairment which prevents them from being able to correctly install some equipment (for example colour blindness).

Goals are regarded as first class entities in the framework system according to the invention. They are defined as abstract, containing variables which must be instantiated at run time. Typically goal variables will be instantiated from a database or from values entered into the user interface. Partial instantiation occurs when items in the goal conditions are left as un-valued variables.

One example of a goal according to the framework of the invention will now be described in more detail. In this example, the goal will be expressed as an XML fragment. The fundamental units of the service-composition framework of the invention are an User Agent (ATAgent) 10 that manages an access Portal 12 (for example, a web site). The User Agent 10 assembles services 22 (POServices) into a composed service manifested as an Action Plan. The Plan is a sequence of Actions such as are shown in FIG. 9 which are provided by the PQServices 22.

Plans are formed by the ATAgent in response to goals which are abstract service requests. A goal can be expressed as an XML fragment—for example—

<goals:goal state=“2”>
<goals:goal-name>Home Security Goals</goals:goal-name>
<goals:description>Get BT Home security</goals:description>
<goals:propositions>
<planinfo:proposition>
<planinfo:assertion predicate=“hasProduct”>
<planinfo:atom literal=“true”>HomeSecurity</planinfo:atom>
<planinfo:atom variable=“true”>SomeCustomer</planinfo:atom>
<planinfo:atom variable=“true”>SomeAddress</planinfo:atom>
</planinfo:assertion>
</planinfo:proposition>
<planinfo:proposition>
<planinfo:assertion predicate=“isa”>
<planinfo:atom>Customer</planinfo:atom>
<planinfo:atom variable=“true”>SomeCustomer</planinfo:atom>
</planinfo:assertion>
</planinfo:proposition>
<planinfo:proposition>
<planinfo:assertion predicate=“isa”>
<planinfo:atom>Product</planinfo:atom>
<planinfo:atom literal=“true”>HomeSecurity</planinfo:atom>
</planinfo:assertion>
</planinfo:proposition>
<planinfo:proposition>
<planinfo:assertion predicate=“isa”>
<planinfo:atom>Address</planinfo:atom>
<planinfo:atom variable=“true”>SomeAddress</planinfo:atom>
</planinfo:assertion>
</planinfo:proposition>
</goals:propositions>
<icon>/images/goals/security.gif</icon>
</goals:goal>

The above XML fragment is demonstrative of how a service composition goal is implemented by the framework according to one embodiment of the invention. This exemplary goal contains a set of assertions with four members
hasProduct(HomeSecurity, SomeCustomer, SomeAddress);
isa(Customer,?SomeCustomer);
isa(Product,?SomeProduct);
isa(Address,?SomeAddress);

The exemplary goal also contains a link to a graphics interchange format (GIF) which is used as information by the framework to build an application front end. Services are defined in XML as well, the service definition contains a header:—

<service-description>
<visibility>expert</visibility>
−
<action name=“ProvisionADSL”>
<description>BT ADSL activation at ?CustomerAddress</description>
...
...

Next an arbitary number “n” of preconditions are defined as in the edge of a di-graph. The precondition given below demands that the proposition
isa (Customer, ?SomeCustomer)

can be evaluated as true at service execution time.

<precondition-edges>
−<proposition>
−<assertion predicate=“isa”>
<atom>Customer</atom>
<atom variable=“true”>SomeCustomer</atom>
</assertion>
</proposition>
...
...

In the same style as preconditions add-effects and delete effects are also defined as propositions:—

<add-edges>
<proposition>
<assertion predicate=“hasProduct”>
<atom variable=“true”>SomeProduct</atom>
<atom variable=“true”>SomeCustomer</atom>
<atom variable=“true”>CustomerAddress</atom>
</assertion>
</proposition>
</add-edges>
<delete-edges>
<proposition>
<assertion predicate=“readyForInstall”>
<atom variable=“true”>SomeProduct</atom>
<atom variable=“true”>SomeCustomer</atom>
<atom variable=“true”>CustomerAddress</atom>
</assertion>
</proposition>
<proposition>
<assertion predicate=“requestedProduct”>
<atom variable=“true”>SomeProduct</atom>
<atom variable=“true”>SomeCustomer</atom>
<atom variable=“true”>CustomerAddress</atom>
</assertion>
</proposition>
</delete-edges>

In the case of the above code, the service will cause the assertion of
hasProduct (?SomeProduct,?SomeCustomer,?CustomerAddress);
   if it is successfully executed. All three of the atoms in this proposition are denoted as variables. In order for it to be meaningful the system must have bound these to some values at execute time and these execution time determined values will be what are asserted in the service-composition framework knowledge base.

The propositions
readyForInstall(?SomeProduct,?SomeCustomer,?CustomerAddress);
requestedProduct(?SomeProduct,?SomeCustomer,?CustomerAddress);
   are delete effects in the above code. They will be matched to existing asserted propositions in the knowledge base and those will be deleted.

In addition to these operators, the service definition provides config information including the root class of the service, and the set of plug-in classes that are to implement it, in addition to non-functional information. Parameters for the plugins defined are also passed in the definition. This information is utilised by the PQService implementation framework developed to support service implementation in the service-composition framework of the invention. For example,

<service-config>
<classname>com.bt.iservice.ws.BasicWebService</classname>
<delay>6000</delay>
<plugins>
<plugin>com.bt.iservice.ws.DSRMessagePlugin</plugin>
<plugin>com.bt.iservice.ws.ControlMessagePlugin</plugin>
<plugin>com.bt.iservice.ws.BasicMessagePlugin</plugin>
<plugin>com.bt.iservice.ws.StatusMessagePlugin</plugin>
<plugin>com.bt.iservice.ws.ResourceMessagePlugin</plugin>
</plugins>
<resource-provider>
<capacity>1</capacity>
<duration>28800000</duration>
<cost>4</cost>
<available-from>1086091497125</available-from>
<available-until>1186091497125</available-until>
</resource-provider>
</service-config>

Solution Design and Acceptance

In the framework service composition is performed via a straightforward means end planning episode based on the Graphplan algorithm [for example, see Blum, A. and Furst, M. 1995. Fast planning through planning graph analysis. In Proc. IJCAI-95 (Extended version appears in Artificial Intelligence, 90(1-2))]. In addition to the composition of services via logical planning, composite services are refined by testing them for tractability (that is can they be executed given the service actions available now) and feasibility (that is can the choreography of the services be created given their temporal properties and the resource availability). Reasoning is done over a closed world assumption. The results of these reasoning episodes are the solutions that can be offered to the user.

Fulfilment Scheduling

This information can be fed back to the user in the form of plausible and executable plans allowing the user to participate in the service design episode. Plausible plans are those that have passed the tractability (planning) test and executable plans are those that have passed the feasibility (scheduling) test. The developer is able to intervene in these interactions to control the dialog between the ATAgent and the user during service design. For example in our customer service examples only one plausible plan is shown to the user and feasibility testing is performed during an interactive scheduling episode allowing an exploration of the times when appointments can be made and kept.

Scheduling is decentralised with each of the services that are composed into the solution operating its own appointment book and managing its own availability. When PQServices can provide appropriate actions and are available they may be selected. Scheduling information and activity will typically be managed by various external systems depending on the particular type of legacy or physical system that underpins the service that is being considered. These details are abstracted into the PQServices ability to provide availability information to the portal.

Delivery and Execution Management

Execution occurs after a feasible plan has been created and rendered into an executable process. The creation of a process in an explicit business planning language was necessary to provide upfront assurance to the user. As we have discussed while a process is created and checked to be feasible any number of events such as service failure can occur. It is then available for inspection by the user or any monitoring authority.

The process is executed using the process engine.

Checking Inputs & Preconditions

Many of the actions that are executed during the execution of a business process are non-transactional (in the sense that their state cannot be preserved and then rolled back if execution fails). This can result perhaps if an action is written in COBOL, or perhaps because they are implemented in the form of a process which results in the actions becoming inseparable. None of these actions will necessarily generate an exception, but they are useless or harmful because they are undertaken during a failure mode before it is detected and disrupt the transactional state of the process. In order to permit process consistency to be preserved the inputs of actions can be checked to ensure that they are consistent with proper execution before services begin to raise exceptions because they are mal-provisioned.

While inputs are typed parameters for services, preconditions are the logical constraints on the conditions required for an action to be available, and are primarily used to perform planning. Input checks are constraints on the values of the world, and are primarily used during execution to ensure that values are still within expected bounds. Inconsistency of an input results in an exception. However, preconditions can be checked at runtime to ensure previous actions have brought the conditions of the processes environment to the required state, and inputs can be checked at planning time to ensure the plan being produced is not expecting values that are not currently found in the world.

Exceptions

Two types of exception are implemented, namely, service instance failure and service class failure. These exceptions are generated either by the PQServices during service invocation or by the user via the ATAgent.

If a Service-instance-failure occurs a logical service substitution is possible without replanning. A POService that provides an alternative instance of the required service will be available at the scheduled time and a direct substitution can be made. If no PQService can be scheduled then the process will fail (in a Service class failure) and a replanning episode will be required to handle the exception.

The state of the known world within the ATAgent will become inconsistent with the expectation of the planner when the exception occurs. Replanning will automatically account for these possibilities as the planner will generate a new plausible process to resolve the relevant goals, if there are any such processes available.

Implementation & Standards

FIG. 7 shows the implementation of the framework system in the preferred embodiment of the invention and its context of deployment. Infrastructure components such as the Apache Axis server and the Tomcat server are used in this embodiment of the invention, although those skilled in the art will appreciate that other web service parsing and hosting solutions can be utilised in alternative embodiments. Apache Axis is an open source implementation of the Simple Object Access Protocol (SOAP). SOAP is an XML-based communication protocol and encoding format for inter-application communication. The SOAP protocol enables data to be exchanged between machines in a distributed environment. Axis is a SOAP engine—a framework for constructing SOAP processors such as clients, servers, gateways which is generally implemented in Java. Tomcat is the servlet container used in the official reference implementation for the Java Servlet and JavaServer Pages (JSP) technologies. The Java Servlet and JavaServer Pages specifications are developed by Sun under the Java Community Process.

The framework planner 40 generates processes in a process description language that is based on Business Process Execution Language for Web Services (BPEL4WS). A proprietary process engine is then used to interpret and execute these processes by invoking the actions (over a SOAP bridge) that are provided by the PQServices in the system.

In FIG. 7 the framework implementation architecture enables the implementation of applications based on a three tier model utilizing the Agent/Service system provided by the framework. Goals (i.e., services) generated from an interaction by a user with a web application can be asserted into the framework and the results monitored and displayed using the web application's interface capability.

Personalisation/Session Management

The ContextDB 18 and UserDB 20 data stores contain information that can be retrieved and updated using the session keys generated when users login to the system during the need identification phase.

The framework 14 manages the knowledge context for the planner 40 using this information, enabling the generation of plans are personalised to the user. Multiple users may utilise the same framework instance via different sessions simultaneously, and in each session planner 40 will be provisioned only with the appropriate knowledge for each user.

As services execute they can/will generate updates to the ContextDB 18 or UserDB 20. These updates change the knowledge that will be provisioned to the planner 40 at the next episode resulting in modified plans being generated.

In the embodiment shown in FIG. 7 the GoalDB 16 ContextDB 18 and UserDB 20 are stored in the SQL database 54. As are the directory services 4. It will be understood that a multiplicity of databases can be used as the implementation resource for these data stores and that they do not necessarily have to be stored using SQL, but could be stored using for example XML, RDF, OWL or Java data structures or other suitable data formats.

The portal 24a is implemented using JSPs 52 and JavaBeans 50 which are run by the Apache Tomcat server 60 and accessed by the user 62. The ATAgent 64 is implemented from components Matchmaker 66 Scheduler 42 Planner 40 and Execution Engine 44. It is understood that the Matchmaker may be a pattern matching and selection type of component or it may be implemented using one of many market algorithms commonly known to those skilled in the art. Apache Axis 58 is used to provide a messaging backbone or bus for the communication between the ATAgent 64 and PQServices 68 and it is understood that this could be replaced with other messaging systems such as Corba or MQSeries messaging.

Toolset

A development environment which utilizes the invention is provided with integration to Java editors and Unified Modelling Language (UML) diagramming to support the development components and conditions for framework based systems according to the invention.

In this embodiment of the invention, the Eclipse system was selected as the IDE and used to construct plugins for service markup, test condition creation, UDDI snapshot and import and goal definition as well as plan generate and test.

The plan generation and test module is implemented to view the produced plans in the form of a malleable graph rendered with the Eclipse Graphical Editing Framework but it will be understood by those familiar with the state of the art that similar rendering could be performed using C++ or Java Swing toolsets or other similar systems for drawing graphics on computer display devices. FIGS. 8A and 8B show a screen of the toolset plan inspection Plugin, Component Editor and UML (using the “OMONDO” plugin shown in Eclipse)

The plans rendered permit the developer utilizing the framework to test the viability of the system that is being implemented and analyse and inspect its behaviour before deployment.

Service markup can be done using Ontology Web Language for Services (OWL-S) in one embodiment of the invention. Alternatively, any other suitable XML markup can be used. Developed services can be exported to the framework and the deployment environment via standard interactions using wizards and forms to configure the environment.

Whilst an agent developer must know what it is that the agents developed are to do, e.g., the agent's motivations and how the agent is to act in particular circumstances, the causal agents in the system remain the developer and the users. The task of the agent system is to act over the encoded knowledge and the development environment to be used must enable the developer to make the requisite knowledge encoding.

The framework toolset according to the invention supports the requirement for a system to allow a developer to check the potential for the system to perform the users required tasks and to experiment with new configurations. Thus the toolset has three features. Firstly, a mechanism for snapshotting and importing service environment states. This mechanism allows the developer to produce a “achieve and test” system within a specific environment state or set of environment states.

Secondly, the toolset utilises the “test” capability of the framework planning engine to produce possible plans in response to developer requests. These plans have no first class object status; they are artefacts for the developers inspection only and are never deployed or saved for later use (they are saved for later reference, inspection and audit).

Finally, a service annotation system that allows the markup of services with applicability and effect information (preconditions and postconditions/add effects/delete effects) to facilitate rapid deployment and round tripping of services from deployment to development and back again to facilitate maintenance.

UDDI Snapshotting & Test Environments

A UDDI snapshot is the result of a query to a UDDI server at a particular time, producing a collection of service descriptions. This snapshot is stored as a file and can then be imported into the framework toolset space using in the current embodiment an Eclipse wizard. A collection of these snapshots can be stored and retrieved by the developer using plugins developed for the Eclipse tool in the current embodiment. These are used as test environments by the developer to test and inspect plans as shown in FIG. 8a. It will be understood by those skilled in the art that the snapshots could be stored and retrieved using other methods, such as a database or a simple Java program or the functionality could be reimplemented into a stand alone tool such as the Zeus development tools.

New service definitions are also created using an Eclipse wizard. The wizard obtains the basic information on the new Service and then creates a basic definition file. This is then opened by the environment using the Service plugin to provide an editor that is used to markup the service. Planning knowledge (such as user specific assertions retrieved from a putative user context) can be created using the conditions wizard and plugin, as are Goals in the form of the Goal conditions that are to hold on if a successful solution is executed. All of the items defined in this way are tied together in a naming scheme/ontology so variable identifiers in a condition and a service with the same tag share an identity in the environment's context.

Test Planning & Process Engineering Support

Once the developer has established the service environment required in the form of the services that will be available and the conditions that are asserted in the environment, the test mechanism can be invoked via a wizard to discover if defined goals can be resolved by the planner given the defined resources. The process of testing is that the process creation wizard is invoked, takes in specifications of which services, conditions and goals to use, and is then invoked. If a resolution is possible the resulting process, showing the service ordering and flow, will be rendered for inspection. If no resolution is possible the planning graph created during the episode is rendered as text for the user to use as a debug trace. In the future we plan to provide introspection tools to enable these traces to be better investigated and navigated by the user.

Service Markup and Roundtripping

In one embodiment of the invention, the above services are annotated using the provided editors. The annotations are rendered into XML by the system and are saved into a file for use in deployment. The services are implemented in Java to provide the required functionality and utilise the markup files and API's to automatically register themselves in selected UDDI servers when they are initialised. This provides a mechanism for roundtrip engineering where service descriptions downloaded from the operational system can be altered and the service implementation changed to accommodate the new requirements and then redeployed.

One embodiment of the invention will now be described in which a customer service portal for a service company is provided using the service composition framework and toolset according to the invention.

Numerous organisations offer intelligent customer support via their web-sites. For example computer suppliers permit online customisation of machines before they are ordered and book sellers provide selection information and prompts in the form of offers and “other users liked” trails. The purpose of these portals is to facilitate the user ordering process and to cross-sell other products to the users.

In service industries, by contrast, the customer service front end of the company is tasked with matching customer requirements with available products and with organising and orchestrating the delivery of these products. Typically the products are complex in that they are combinations of many other sub-products, ephemeral & intangible in that they cannot be stockpiled, and/or user dependent in that they require the user to be involved in their delivery; for example by answering questions from engineers over the phone, opening premises or installing and activating components.

The service composition framework in this embodiment is implemented to provide a backend for a service portal for the service industry. Its particular role is to provide on-line support for the procurement and delivery process of complex services from large service portfolios. FIGS. 9A and 9B show screen shots of an appropriate web-interface which enables user requirements to be gathered. In FIG. 9A, users are provided with a web interface from which they can make service selections. Singular service selections are unproblematic, and only services which are known to be deliverable are offered to the customer.

However, frequently customers wish to obtain bundles of services, for example a broadband internet connection, video on demand, a PC and a TV. Two sets of problems arise from such a scenario. From the users perspective the questions is how do they know that all the services requested will work together, and how will these items be delivered in a convenient fashion? Users do not want to spend hours coordinating this process themselves. Secondly, from a business perspective, how can the fulfilment processes of these services be coordinated for efficiency?

The invention seeks to provide a service-composition framework which resolves these problems by enabling the framework to implement a system which is capable of progressing to an information gathering phase. This information gathering phase is dependent on the services requested and is driven by the need to unify the goals that the request for services will generate. Variables such as a delivery address which is not currently know must be entered by the user or retrieved from another source. This is the Need Identification and Solution Design phase in the service composition framework and the implementation of them for this application is shown in FIGS. 9A and 9B.

When all information is obtained a plan is made and the user is able to interact with it. The user is presented with a list of the times when they will need to do something (like let an engineer onto premises) according to the plan created. The user can then alter these times to suit their preferences, within the bounds permitted by the feasibility tests of the system. Once feasibility is agreed the user is presented by an itinerary of action and the progress of the workflow is reported to them via this interface on their portal homepage. FIGS. 10A and 10B show the implemented pages for these phases in the service ordering portal application. FIGS. 10A and 10B are screen shots showing the user appointing stage, fulfilment scheduling stage and delivery execution stage in this implementation of the service composition framework. In this embodiment, the user is able to make additional requests and if exceptions are raised during execution this will be apparent here to the user as will any changes of plan required.

The server side monitoring screens implemented in the service composition framework is shown in FIG. 11 of the accompanying drawings. In FIG. 11, a screen shot is shown in which a monitoring screen 800 on the left hand side of the figure shows the delivery process planned for a Security and Music bundle delivery which is being processed by the Execution Engine 44. On the right, a window 802 shows a service directory providing the services for this application.

The invention has been presented as a model in which limited interaction between an assistant agent (ATAgent) and a number of tightly defined services (PQServices) is used to provide knowledge and action for dynamic applications. No formal communication semantic or formalised the interaction model between the ATAgents and PQServices is required for these embodiment of the invention, as those skilled in the art will appreciate. Whilst the embodiments described herein implement a communication system that is ad-hoc in nature and works well enough in the closed settings, those skilled in the art will appreciate that the spirit and scope of the invention can create an open implementation if more formalised semantics and a formal interaction model and protocols are provided.

Thus the invention provides a framework for building applications which assist users in composing web services congruent with REST design principles and philosophy. It provides a powerful intelligent problem solving tool set which has been structured to provide as much support for developers as possible by narrowing the set of concerns that they are obliged to consider when developing an application. In addition the model of service development supported by the service composition framework according to the invention is designed to realise loosely coupled reusable applications. The toolset the invention provides assists developers in validating the process support for the applications that they create.

Those skilled in the art will be aware that the above description describes a generic framework capable of providing support for creating a particular type of application, while retaining the core characteristic of flexibility in the face of dynamism and change. Nonetheless, additional features and functionality can be implemented in alternative embodiments of the service composition framework 14. In particular negotiation for resource selection, sophisticated communication constructs, powerful domain and service ontologies and forward chaining reasoning components would obviously supplement the functionality of the service composition framework 14.

The web services composition framework seeks to provide an environment supportive of the development of agent based systems which comprise intentional programs having goals which are solved in the face of dynamic conditions and uncertain action outcomes. If the goals for an agent are created by the system programmer or knowledge engineer then they can be considered as invocation instructions with the agent system free to resolve the goal in various ways using its reasoning system, depending on the state of the system. Alternatively, the goals for the web services composition framework

The selection of services by a user requires certain fulfillment processes to be performed. These processes are required to design, order, supply and deliver the services and these processes should take into account the other services the user has either ordered or already had provided to take advantage of any interactions between services of benefit to the customer and/or service provider. This ensures the fulfillment activities are appropriately optimised.

As an example, consider when a VoIP solution is being ordered by a customer. This requires the capabilities of the Ethernet network and routers that the customer has already installed to be considered to prevent respecification and/or re-order of the customer's pre-existing infrastructure. If a Virtual Private Network is to be set up simultaneously, the survey visits required to install both sets of equipment should be co-scheduled. The creation of a fulfillment process must take place within a context which is updated by events such as a successful completion of an activity or the failure or disconnection of a device to ensure that the optimal process is followed. This context includes the process actions or steps that are permitted for the customer and the information known about the customer. The invention provides a mechanism of automatically deriving such a process from the information maintained in the customer context and the requirements expressed by the customer.

In one embodiment, the invention provides tool set of developing service orientated agent systems also referred to herein as “KRENO”. This tool set (“KRENO”) assists the developer of a Service Orientated Agent System with deliberative behaviours. The tool set provides a mechanism for developing a system that exploits knowledge and resources unknown to the developer at compile time. This embodiment provides development support for the particularly complex domains associated with the widespread Grid, Web Service and Ubiquitous Computing visions. The embodiment also supports enterprise integration, a methodology for ultilizing tools in an engineering context, and support for developer round tripping, i.e., support to enable the developer to take a system with a problem, fix it and return the system.

This embodiment of the invention is concerned with developing technology for provisioning and utilizing (engineering with) knowledge for a situated agent in a dynamic environment. A goal can be defined as the result of an interaction or the required outcome of a request and context is defined in terms of the request made in terms of the availability of the services and the conditions in the environment.

For example, consider a portal arranged to provide a service for the selection of telecom's services based on the features that the customer desires. New products are added, inventory changes, and the customers circumstances change. The agent managing the portal uses it's planner to provide best effort services based on the companies ability to procure and fulfil orders for the equipment and to install it in the required time windows.

There is a disjoint between the requests being made on it and the tasks that it chooses to undertake to satisfy them. For example, the simplest, cheapest PBX that satisfies all the customers needs could be BOX A but if these are out of stock a BOX B product with a specialised configuration could be substituted. The system does not model “how a BOX A would be delivered” it models “how are these features provided given the current service availability and starting configuration”.

The enumeration of the portfolio of planning scripts to support planning agents in different contexts, with different goals is a significant engineering task; the generation of the plans from declarative knowledge structures seems, by inspection, to offer a way to short-circuit this requirement by providing for the development and audit of critical paths in the Service Orientated Agent Systems (SOAS) and supporting the expectation of the developer and user that the SOAS will be able to deduce the correct actions in other cases, exceptions and contexts.

A SOAS is a set of sets containing tuples of the form: <gu, ga, components, state>

Where ga=goals known to be achievable; gu=goals known to be unachievable; components=services available; and state=initial state. Goals are the set of states which are to be achievable by the SOAS in response to a human request. Achievable goals are those for which the developer has obtained an executability proof, unachievable goals are those where no proof has been created (which could mean that no agent can perform them given services and state).

state is the set of propositional assertions <a1, a2, . . . , an> that are true when the proofs of achievability are to be obtained. ax is a proposition of the form: tag(atom1, atom2, . . . , atomn), where the tag is a signifier and atoms are either variables, literals or values.

components are a set <s1, s2, . . . , sn> where sx is an action statement of the familiar form <precondition, add effect, delete effect, input, output> where the semantic of planning layer (pre/add|del) and data layer (in/out) state the transactional semantic of the action sx.

<precondition, add, del input, output> are sets of propositional assertions of the same form as in state.

A proof is a sequence of sets of services:
<{sa1, sa2, . . . , san}, {b1, sb2, . . . , sbn}, . . . , {sx1, sx2, . . . sxn}>

Such that all preconditions of {sa1, sa2, . . . , san} are members of state and each sequential member of the proof has a valid unification of all preconditions in its set in the post conditions of the previous member of the set.

The purpose of the tool set comprising this embodiment of the invention is to enable the developer to create a consistent, abstract and general SOAS so that variables and values are correctly unified. This will enable the development of systems that take advantage of preexisting service infrastructures and are developed to adapt to new or alternative environments as they arise; and this behaviour can be systematically implemented, tested and audited. The toolset also enables the translation of the SOAS into a deployed system of services and agents using a particular set of recognised enterprise middleware standards (the web-service canonical stack of SOAP, WSDL, XML and UDDI). The twin objectives are motivated by developers desires to create systems that do something; that are functional, and the need to provide testing and validation trails for what has been created. The SOAS developed in this tool set can be used to demonstrate that the deployed system will work in various differing environments, for example, in the UK, German and Asian market environments as defined by various state and services elements.

In this embodiment of the invention, the tool comprises tools that are used to support the annotation and manipulation of service resources, for example:

A mechanism for snap-shotting and importing service environment states from (in our implementation) a UDDI server. This allows the developer to work within a specific environment state or set of environment states.

A service annotation system that allows the mark-up of services with applicability and effect information (preconditions and postconditions/add effects/delete effects) to facilitate rapid deployment and round tripping of services from deployment to development and back again to facilitate maintenance. The service annotation tool allows services to be configured with plug-ins that implement functionality.

A wizard for exporting service definitions into a service framework and deploying services into an operational framework.

Whilst the examples given above comprise tools which are trivial editors, straightforward compilers and file/query handlers, such tools are critically important in facilitating rapid development. Moreover, these tools are important in the general picture of the make up of an IDE for Agent development, however their detailed description is not the main focus of this paper.

Of more interest are the tools which rely on deductive and analytic algorithms, for example:

A service composition assistant that provides advice on the applicability and usefulness of services in the current context to assist in the construction of valid proofs.

A “test” capability which enables the system to produce visualizations of possible plans in response to developer requests. These plans have no first class object status; they are artefacts for the developer's inspection only and are never deployed or saved for later use (they are saved for later reference, inspection and audit).

Service Composition Assistance Tool

In this embodiment of the invention, the tool set comprises a service composition assistance tool. The objective of the service composition tool is to provide developers with advice about why service proofs are not succeeding, or are using unexpected or anomalous means. This is the critical contribution of this embodiment of the invention as advantageously, it removes the need that developers have had in the past to perform the necessary unification and checking mentally or on paper.

In order to provide the advice required first a datastructure; the ActionMatchMatrix is generated with the algorithm for generating the service advice ActionMatchMatrix data, shown later below.

Referring now to FIG. 12, a screen is shown illustrating the service advice editor as implemented on the Eclipse IDE according to one embodiment of the invention. The service advice editor is provided with a graphical user interface which displays a plurality of separate information sets (here in independent windows) related to the service development simultaneously. In this embodiment, the information sets displayed comprise: unsupported preconditions, sufficient components, supported components, supporting components, blocked components and blocking components. Each is set of information listed comprises information derived from an ActionMatchMatrix (which generate the entries for the six panels shown in FIG. 12).

The ActionMatchMatrix is constructed to contain an ActionMatchNode for every service in the current SOAS and a graph of connections to every other node. These links are via the propositions, so the propositions link to their matching propositions in other actions, so an action with a postcondition would have a link from that postcondition to all the preconditions of other actions that it supports, from which it can then determine which actions it supports. The links between propositions are of four types: supports, contradicts, supported-by, contradicted by. The links themselves are not bi-directional, but would usually have a complementary counterpart.

Below is shown the algorithm used to construct the ActionMatchMatrix. The procedure is 2(n−1(O))²complex as it consists of two steps each of which requires an evaluation of each of the components in the SOAS against all of the other components of the SOAS. The cost of O is approximately the cost of a unification of the symbols in all the preconditions of one component against the symbols in the add effects and delete effects of the other component for each of the two steps of evaluating support and contradiction.

For each service make a node <add, del, pre>
in a matrix such that;

add=add effects, del=delete effects, pre=
preconditions
for each node1
for each node2 !=node1
for each node1.pre
for each node2.add
if ∃ unifier(node1.pre,node2.add)
node1.addSupportedBy(node2,add)
node2.addSupports(node1,pre)
end if
end for
end for
end for
for each node1
for each node2 !=node1
for each node1.pre
for each node2.del
if ∃ unifier (node1.pre,node2.del)
node1.addContradictedBy (node2,del)
node2.addContradicts(node1,pre)
end if
end for
end for
end for

The Algorithm for generating the service advice ActionMatchMatrix data.

The panels shown in the editor displayed in FIG. 1 comprise: unsupported preconditions, sufficient components, supported components, supporting components, blocked components and blocking components for a component s. The data that populates these panels is the result of the query to the ActionMatchMatrix described above. As shown in FIG. 1, the panels display the following information:

Unsupported Preconditions: get all the preconditions that do not contain any supportedBy links for s. Formally the set of Unsupported Preconditions, US, displayed on the Service Composition Assistant Tool for component s is:
US={pre₁, pre₂, . . . , preₙ}|∀preₓεUS [symbol] preₓεpre !∃linkεsupportedBy [symbol] link.pre=preₓ

Sufficient Components: get all the components that are linked to by supportedBy links from all of the preconditions of this component.

Formally the set of Sufficient Components, CC, displayed on the Service Composition Assistant Tool is:
CC={s1, s2, . . . , sn}|∀saεCC ∃linkyεsupportedBy [symbol] linky.preεpre

Supported Components: get all the components that are linked to by supports links from any of the add effects of this node.

Formally PC, the set of components that this components add effects support is:
PC={s₁, s₂, . . . , sₙ}|∀sₓεPC ∃linkεsupports [symbol] link.node=sₓ

Supporting Components: get all the nodes that are linked to by supportedBy link from any of the preconditions of this node.

Formally SC, the set of components that provide some degree of support for this component s by having an add effect that is a precondition of s is:
SC={s₁, s₂, . . . , sₙ}|∀sεSC ∃linkεsupportedBy [symbol] link.node=sₓ

Blocked Components: Get all the nodes that are linked to by any contradicts links from and of the delete effects of this node.

Formally BC, the set of components that have a precondition which is a delete effect of this component is
BC={s₁, s₂, . . . , sₙ}|∀sεBC ∃linkεcontradicts [symbol] link.node=sₓ

Blocking Components: Get all the nodes that are linked by contradictedBy links from any of the preconditions of this node.

Formally IC, the set of components that have a delete effect that is a precondition of this components is:
IC={s₁, s₂, . . . , sₙ}|∀sₓεIC ∃linkεcontradicts [symbol] link.node=sₓ

A proof visualization wizard is used to select sub sets of service and conditions with which to test the reachability of collections of goals. This functionality supports the incremental development of composed services based on the familiar developer procedure of generate (code) and test (with assumptions) to see if it will run. In addition this method allows a process analogous to unit-testing to be applied to the service chains that make up composite functionality in SOAS.

In FIG. 13 of the accompanying drawings, the outcome of a “proving” episode is illustrated. An important aspect of the toolset is its use for developing logic for context sensitive situated agents. This is facilitated by its editors and by the functionality of the proof visualisation wizard which consists of a three step selection process:
select components->select goals->select conditions

At each step it is possible to design the structure of the goal solving environment that the proof will be constructed for by selecting the groups of assertions represented in the goal collections or in the component selections.

The above embodiments can be implemented in order to support a development method for compositional systems.

Application analysis according to the above embodiment of the invention is performed by examining the features of the required solutions being requested from the system by the user. These are the abstract goals of the system and need to be distilled from the product specifications or requirement lists provided. No analysis of organizational model or interaction model is required as these are the concerns of the deployment framework and are not considered by the above embodiment.

The Application Development process according to this embodiment of the invention is as listed below.
1. Import test environment from UDDI, including mark-up; use snapshot macros and tool set import wizard.
2. Specify goals for SOAS; each goal is specified as a set of propositions in the goal editor page.
3. Create a set of preconditions that are expected to hold for the proofs to be compiled.
4. Select a goal;
5. Repeat 6. Identify all the services required to satisfy the propositions in the goal; identify all the preconditions in these services using the Assistant tool or from the service editor precondition pane.
7. If there are not services available with the correct postconditions then a new one will have to be created; use the service editor.
8. Create a conditions set containing all preconditions identified above.
9. Create a proof using the proof visualization tool and wizard.
10. The goal is now the preconditions of the services selected or created in 5/6; if all the preconditions are in the set created in 3 then finish.
11. end repeat
12. Implement component functionality (beyond scope of method)
13. Deploy components using the Export Component Wizard into the service directory (UDDI) and application/service container (Apache-Axis)
14. Deploy goals using the Export Goal Wizard to the application framework on Apache-Axis.

Thus this embodiment of the invention enables developers are able to move away from this process when they are confident that they can create groups of components without testing for validity. The invention couples the implementation and design processes tightly and makes a number of limiting assumptions about the deployment environment and application style (3 tier, web enabled) that can be produced. The assumptions go beyond specifying that a 3 tier application will be produced; a specific deployment framework that provides for resource management, booking, presentation, service selection and orchestration as well as service composition is mandated by the use of the Goal deployment wizard. This framework supports the running application that is implemented using the knowledge provided by the tool set according to the above embodiment of the invention.

The toolset described in the above embodiment of the invention is capable of providing a workbench containing tools developed by a team that needed them to implement advanced service orientated systems. The toolset according to this embodiment of the invention is intended to empower the service orientated developer, to enable them to rule over the agent systems that they must produce.

Modifications and equivalents to the features described above will be apparent to those skilled in the art and the scope of the invention is not limited to the specific embodiments described above but is instead defined by the scope of the accompanying claims.

1. A service-composition framework arranged to generate a personalised order process for a user seeking to fulfil a service goal by composing a process from a multiplicity of registered services, the framework comprising:
a service engine configured to compose one or more services into an order for offering to a user, each service comprising a plurality of actions to be performed; and
a portal via which the user can request said one or more services from said service engine to fulfil said service goal, the portal being arranged to enable the user to select which services are to be offered,
wherein the framework is configured to dynamically determine both the plausibility and the feasibility of the services offered to the user whilst the user is executing their request for services via the portal and to maintain the users status and personal information within a session context.

2. A service-composition framework as claimed in claim 1, wherein the services are registered dynamically.

3. A service-composition framework as claimed in claim 1, wherein the execution of any service order updates the context information for the user.

4. A service-composition framework as claimed in claim 3, wherein the context information for the user is updated dynamically.

5. A service-composition framework as claimed in claim 1, wherein the multiple simultaneous sessions for separate users.

6. A service-composition framework as claimed in claim 1, wherein services are selected sequentially to fulfil the service goal, and wherein if the order process fails, the goal is automatically reasserted and at least one new plausible service is offered which is compliant with the outcome of the previous service selected to fulfil the goal if such a process can be generated.

7. A service-composition framework as claimed in claim 1, wherein the registered service is a web-service.

8. A service-composition framework as claimed in claim 1, wherein a registered service comprises an engineering resource.

9. A service-composition framework as claimed in claim 1, wherein a registered service comprises a network resource.

10. A service-composition framework as claimed in claim 8, wherein the registered service is dynamically updated to include a newly available one of said resources.

11. A service-composition framework as claimed in claim 1, wherein newly available resource comprises a resource which was not anticipated by the designer of the framework.

12. A service-composition framework as claimed in claim 10, wherein the newly available resource is made available to the user by modifying the portal.

13. A suite of one or more computer programs arranged to enable a service oriented system to be specified, the one or more computer programs enabling the service orientated system to be specified in such a way that it can be tested in using the same reasoning apparatus that would utilise the service orientated system in actual deployment.

14. A suite of one or more computer programs as claimed in claim 13 arranged to be implemented in a distributed computing environment.

15. A service-orientated system comprising a service-composition framework as claimed in claim 1.

16. Apparatus enabling a service oriented system to be specified, the apparatus enabling the system to be specified in such a way that it can be tested in using the same reasoning apparatus that would utilise the service orientated system in actual deployment, wherein the service oriented system comprises a service composition framework, arranged to generate a personalised order process for a user seeking to fulfil a service goal by composing a process from a multiplicity of registered services, the framework comprising:
a service engine configured to compose one or more services into an order for offering to a user, each service comprising a plurality of actions to be performed; and
a portal via which the user can request said one or more services from said service engine to fulfil said service goal, the portal being arranged to enable the user to select which services are to be offered,
wherein the framework is configured to dynamically determine both the plausibility and the feasibility of the services offered to the user whilst the user is executing their request for services via the portal and to maintain the users status and personal information within a session context.

17. Apparatus as claimed in claim 16, further comprising means to test the system implementation of one or more of the steps in a method of generating a personalised order process for a user seeking to fulfil a service goal by composing a process from a multiplicity of registered services, the method comprising:
configuring a service engine to compose one or more services into an order for offering to a user, each service comprising a plurality of actions to be performed;
requesting using a portal said one or more services from said service engine to fulfil said service goal, the portal being arranged to enable the user to select which services are to be offered,
determining dynamically both the plausibility and the feasibility of the services offered to the user whilst the user is executing their request for services via the portal and to maintain the users status and personal information within a session context.

18. A toolset for use in a software development environment, the toolset arranged to enable testing of a service-composition framework arranged to generating a personalised order process for a user seeking to fulfil a service goal by composing a process from a multiplicity of registered services, the framework comprising: a service engine configured to compose one or more services into an order for offering to a user, each service comprising a plurality of actions to be performed; and a portal via which the user can request said one or more services from said service engine to fulfil said service goal, the portal being arranged to enable the user to select which services are to be offered, wherein the framework is configured to dynamically determine both the plausibility and the
feasibility of the services offered to the user whilst the user is executing their request for services via the portal and to maintain the users status and personal information within a session context, the toolset comprising at least a planning tool for the framework which enables the framework to be specified in such a way that it can be tested in using the same reasoning apparatus that would utilise the framework in actual deployment.

19. A service-composition system arranged to generating a personalised order process for a user seeking to fulfil a service goal, the system comprising:
service composition means configured to compose one or more registered services into an order for offering to a user, each service comprising a plurality of actions to be performed;
means via which the user can request said one or more services from said service composition means to fulfil said service goal, said means via which the user can request services being arranged to enable the user to selectively control which services are to included,
wherein the system is configured:
a) to dynamically determine both the plausibility and the feasibility of the services offered for selection by the user to fulfil the desired service goal; and
b) to update the range of registered services offered in dependence on the extent to which the services currently selected by the user achieve the desired service goal.

20. A method of application development comprising the steps of:
a) importing a test environment from a service directory (UDDI);
b) specifying a goal for the service orientated agent system as a set of propositions in a goal editor;
c) creating a set of preconditions that are expected to hold for each proof to be compiled;
d) selecting a goal;
e) repeating the following steps for each selected goal:
f) identify all the services required to satisfy the propositions in the goal;
g) identify all the preconditions in these services using a service editor precondition pane or other service editor assistant tool;
h) if there no services are available with the correct postconditions, creating a new service using a service editor;
i) creating a set of one or more conditions containing all of the preconditions previously identified;
j) creating a proof;
k) determining that the goal comprises preconditions of the services selected or created in steps d) and e) above;
l) if all the preconditions are in the set created in step c) then finish (end repeat);

21. A method of application development as claimed in claim 20, further comprising the steps of:
m) implementing each component's functionality;
n) exporting the plurality of components for deployment into the service directory (UDDI) and application/service container; and
o) deploy each goals to the application framework.

22. (canceled)

23. (canceled)

24. (canceled)

25. (canceled)

26. A method of generating a personalised order process for a user seeking to fulfil a service goal by composing a process from a multiplicity of registered services, the method comprising:
configuring a service engine to compose one or more services into an order for offering to a user, each service comprising a plurality of actions to be performed;
requesting using a portal said one or more services from said service engine to fulfil said service goal, the portal being arranged to enable the user to select which services are to be offered,
determining dynamically both the plausibility and the feasibility of the services offered to the user whilst the user is executing their request for services via the portal and to maintain the users status and personal information within a session context.

27. A method of configuring a system to ensure a user-defined service goal is provided by a plurality of parties, the system including means to provide a user with access via a communications network portal operated by a second party to means to request one or more services from a service engine to fulfil said service goal, the portal being arranged to enable the user to select one or more services to be offered to achieve said user-defined goal, the method comprising:
the user requesting one or more services by composing a process comprising a plurality of service tasks using said portal, each said service task to be performed by one or more of said plurality of third parties,
automatedly configuring said service engine to compose one or more service tasks into an order for offering to a user, each service task comprising a plurality of actions to be performed; and
configuring the system to dynamically determine both the plausibility of the services and the feasibility of the services offered to the user whilst the user is executing their request for services via the portal and to maintain the users status and personal information within a session context.
